(19) United States
(12) Patent Application Publication
(10) Pub. No.: US 2024/0288540 A1
(43) Pub. Date: Aug. 29, 2024

(54) SELF-CALIBRATING RADAR SENSOR FOR BEAM PREDICTION DISCOVERY

(71) Applicant: Tektronix, Inc., Beaverton, OR (US)

(72) Inventors: Keith R. Tinsley, Beaverton, OR (US); Sangsu Lee, Sunnyvale, CA (US); Saad Mufti, Alpharetta, GA (US)

(73) Assignee: Tektronix, Inc., Beaverton, OR (US)

(21) Appl. No.: 18/436,661

(22) Filed: Feb. 8, 2024

Related U.S. Application Data
(60) Provisional application No. 63/448,613, filed on Feb. 27, 2023.
(60) Provisional application No. 63/454,918, filed on Mar. 27, 2023.
(60) Provisional application No. 63/459,974, filed on Apr. 17, 2023.

(51) Int. Cl. G01S 7/40; G01S 7/295

(52) U.S. Cl. CPC G01S 7/4021; G01S 7/2955

(57) ABSTRACT

A communication network has multiple nodes, each node having one or more antennas, one or more input ports to receive communication signals from the antenna, a memory to store data associated with the communication signals, and one or more processors to gather local data about an environment, communicate with other nodes as needed, and use the local data to determine optimized operational settings for the node. A sensor device has one or more antennas to receive communication signals from other nodes in a communication network, one or more input ports to receive the communication signals, one or more output ports to transmit communication signals, a memory to store data associated with the communication signals, and one or more processors to determine a position of the sensor, transmit signals, receive return signals, produce return signal data, and use a machine learning system on the return signal data to identify unblocked ports.

### CROSS-REFERENCE TO RELATED APPLICATIONS

This disclosure claims benefit of U.S. Provisional Application No. 63/448,613, titled, “SELF-CALIBRATING RADAR SENSOR OR PROBE FOR BEAM PREDICTION DISCOVERY,” filed Feb. 27, 2023, and U.S. Provisional Application No. 63/454,918, titled “MULTI-CHANNEL FEDERATED LEARNING FOR BEAM PREDICTION AND CHANNEL ESTIMATION,” filed on Mar. 27, 2023, and U.S. Provisional Application No. 63/459,974, titled “DISTRIBUTED FEDERATED TEST AND MEASUREMENT SYSTEM FOR DEVICE UNDER TEST CHARACTERIZATION, SUSTAINMENT, COMMAND AND CONTROL, filed on Apr. 17, 2023, the disclosures of both of which are incorporated herein by reference in their entirety.

### TECHNICAL FIELD

This disclosure relates to test and measurement systems, and more particularly to a test and measurement system for device under test characterization, sustainment, command, and control using distributed sensors and central node.

### BACKGROUND

Sixth generation (6G) wireless communication systems present issues with beam management, initial access, and beam selection, also known as beam forming. Other networks such as satellite communications and scientific instrumentation networks face the same problems due to the number of nodes and various sensor link typologies across defined networks' boundaries.

Several approaches to these problems exist. Initial access solutions relate to the increased beam management overhead due to elongated time-frequency resource allocations. These allocations are not well served by traditional exhaustive search (ES) methods in which user equipment (UE) searches for a connection, marked by prolonged allocation of time-frequency resources that yield only suboptimal beamforming codebook subsets and a high missed probability of detection rates.

Some compressed sensing techniques have shown significant enhancements in low signal-to-noise (SNR) environments, leading to improved missed detection probability in MIMO (multi-input multi-output) systems with up to 256 antennas. This provides justification for investing in algorithms and techniques over extended search approaches. Another approach uses an iterative technique that addresses initial access through a multi-staged algorithm that optimizes beam direction, sweep rate, and missed detection probabilities. This approach delivers improvements of more than 50% over other extended search approaches, but still needs improvement.

Some approaches utilize position information and intermediary microstations (sensors), along with calibration waveforms, to determine the optimal beam learnings. This resulted in determining optimal beam codebook subsets that afford reasonable initial access delay (impacts) and missed detection probability performance.

The increased capabilities of artificial intelligence in the form of machine learning will assist with these issues. The use of machine learning comes with its own requirements. Model training and validation must meet strict standards and undergo testing and measurement and be sustainable.

One approach uses sensors as distributed probes in the communication system. This approach separates sensing frequency modulated continuous wave (FMCW) waveforms and communication signals (orthogonal signaling) via covariance estimations and mappings, inputs used to train candidate neural network architectures (NNA). These NNAs lead to unique characterizations of environments that can be transferred to digital twin (DT) facsimiles or fellow standards participants.

A critical test, measurement, and sustainment (TMS) task involves monitoring or sensing conditions in the network. Embodiments here provide solutions for these problems.

### BRIEF DESCRIPTION OF THE DRAWINGS

FIG. 1 shows an embodiment of a communication network.

FIG. 2 shows an embodiment of a network node with machine learning capacity that includes a test and measurement device.

FIG. 3 shows an embodiment of a radar sensor and a set of output signals.

FIG. 4 shows a signal diagram for a radar sensor.

FIG. 5 shows a block diagram for a radar sensor and a machine learning network.

FIG. 6 shows an embodiment of an ensemble convolutional neural network.

FIG. 7 shows an embodiment of a distributed federated learning architecture.

FIG. 8 shows an embodiment of an ensemble neural network for beam prediction.

### DESCRIPTION

The embodiments here provide a test, measurement, and sustainment (TMS) network using available interconnections in a defined system. The embodiments here address edge processing, meaning the devices that exist at the ‘ends’ of the networks, of device situation or conditions that warrant test and measurement precision, accuracy, and metrology. In the context of 6G communications, the wireless communications systems, including terrestrial and non-terrestrial MIMO (multi-input multi-output) networks systems, and scientific instrument networks provide an example of this type of system. No limitation to testing and measurement only applying to a communication system is intended, nor should any be implied.

The embodiments include an overall system architecture of sensors or probes, referred to herein as sensors, mixed in with network nodes to monitor the network environment, and a machine learning system that can utilize the information gathered by these sensors to predict the best settings and configurations for the system. The network environment provides merely one example of a type of system that may benefit from this type of architecture. The test and measurement realm may comprise other types of systems other than wireless systems. The realm may include test and measurement of devices outside of wireless devices. These devices may include electrical, mechanical, optical, acoustic, or thermal devices, as examples, that the nodes enable to allow information about these devices to travel across the network for test and measurement purposes.

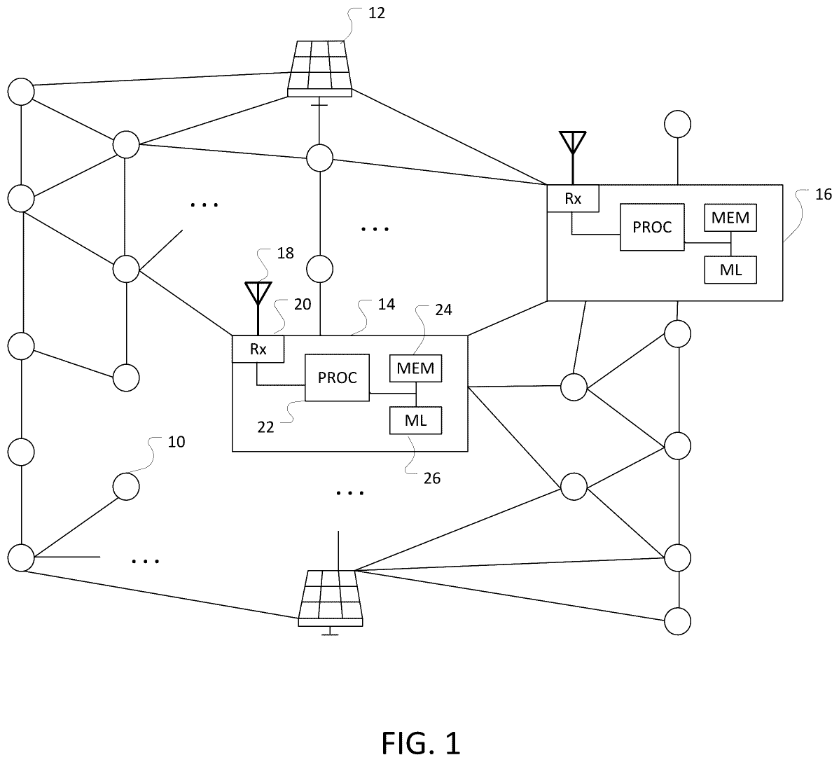

FIG. 1 shows an embodiment of a communications network. The network has multiple nodes, anywhere from a handful of nodes to thousands of nodes. Each node comprises a device that communicates with other devices on the same or other nodes in the network. The device may connect through the communication protocol of the network, typically, but not limited to radio frequency (RF) communications, directly or the device may connect to another device that provides access to the network. The types of devices residing at the nodes may comprise simple radio relay stations, computing devices such as cell phones, desktop and laptop computers, servers, cloud storage repositories, reconfigurable intelligent surfaces (RIS), test and measurement instruments, etc. The network nodes shown in FIG. 1 mostly exist in the “front haul” of the network, meaning the portion of the network that communicates through wireless channels in the air space, sometimes referred to as the “ether.” Some nodes connect between the wireless devices and servers through wired connections, although not necessarily. The portion of a network that connects between the wireless front haul and the servers comprises the “back haul” of the network. The backhaul typically comprises wired connections, although some networks rely on a satellite backhaul.

FIG. 1 shows nodes, such as 10, that may include any of the above devices. Other nodes may include servers or other central nodes such as 16, RIS devices such 12 used to relay signals from configured antennas having optimal beam forming, and a sensor device 14, which may also comprise a test and measurement device such as a real-time spectrum analyzer.

A test and measurement device typically has one or more ports 20. These ports may connect by cable or wirelessly to a device on the network or may themselves connect to the network such as through antenna 18. The ports generally include a port to receive signals, from a device under test (DUT) such as a sensor or directly from the network. These signals allow the instrument to analyze the signals and make some determinations as to the functioning of the DUTs in the network or of the network environment itself. The DUT may comprise a device of many different types, operating with physical signals and devices that include, but are not limited to, electrical, mechanical, optical, acoustic, or thermal devices, as examples. The processor(s) at the node takes this information and interfaces with the ports that connect the device to the network to communicate the information related to the physical layer of the device (PHY) out to the network.

Processor 22 represents one or more processors that take the signals, analyze them, and provide outputs to allow analysis of the signals, such as a display for users to view, or to be transmitted to other devices to report the analysis. The device may also include a memory 24 to store the incoming signals and analysis and the executable code executed by the one or more processors to perform the functions discussed herein. If the device 14 comprises a sensor in the network, it may have less processing capacity than a test and measurement device.

As will be discussed in more detail later, device 14 may also include a machine learning component. Central node 16 may comprise a device having more processing and storage capacity, such as a server as an example. The central node 16 otherwise has similar components to device 14, but the machine learning component 26 of device 14 may only comprise a connection to a machine learning system. The machine learning system may comprise one or more of many different types of machine learning topologies, including but not limited to one of the many types of neural networks such as convolutional neural networks, feed-forward networks, etc., support vector machines, decision trees, linear or logistic regression, random forest, etc. The discussion below will focus on neural networks and will use the term “machine learning network,” but no limitation to that particular type of machine learning system is intended, nor should any be implied.

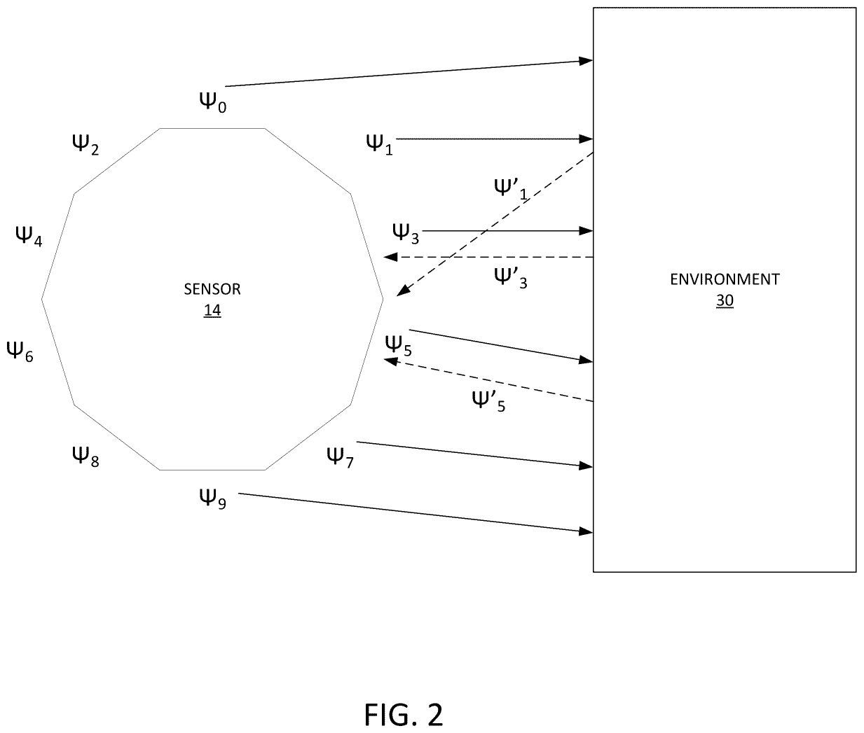

The discussion here will begin with a discussion of a local use of machine learning at a sensor within the communications network then move to a broader, network wide implementation of machine learning across the entire network. FIG. 2 shows an embodiment of a sensor, which could comprise device 14 of FIG. 1, within a network. The sensor in this embodiment has machine learning capabilities.

Sensor 14 uses its capability to determine the existence of, and how to address the problems arising from, a blockage in the network. This process may occur continuously as the nodes in the network will generally move and change and adapt as conditions and the environment 30 changes. The sensor may comprise a part of a disaggregated test and measurement system within the communication network to allow monitoring of the network conditions, performance, and issues. This allows network operators and participants to adjust to ensure the network operates at its highest efficiency.

This system employs artificial intelligence (AI) in the form of machine learning (ML). Machine learning may take the form of transfer learning, semi-supervised transfer learning (SSTL), or semi-supervised federated learning (SSFL) to extract data to support infrastructure performance goals through sensing and derived ML optimizations.

As an example of its operation, the sensor may use a frequency modulated continuous wave (FMCW) signal to determine blockage and a multi-dimensional Fast Fourier Transform (FFT) to precondition data, promoting ML self-labeling, to learn the corresponding environment to empower 3D mapping and predict an optimal beam prediction vector.

Communication system management complexities, highlighted as initial access (IA) limitations, are well documented. These necessary complexities contribute to physical (PHY) link maintenance, resulting in extended time through added overhead, and give rise to quality of service (QOS) impacts. Some previous work has highlighted a necessary extension with respect to interference coordination to facilitate full duplex operations. In addition, beamforming and power management warrant investigation into infrastructure tasks that can be conducted on average, alleviating impacts to current air interface-based channel setup overhead requirements; impacts exacerbated by multiple input multiple output antenna (MIMO) based systems.

Previous work has also discussed extending integrated sensing and control (ISAC) functional roles to include reconfigurable intelligent surfaces (RIS), the placement and performance specifications of which could be tuned to maximize spectral efficiency or coverage for a given location, given sensed environmental constraints. One approach using RIS structures discussed a functional split between fast and slow-moving channels, to allow for computations to be performed more slowly and minimize mobile channel optimization tasks, specifically highlighting impacts due to heavy beamforming training overhead.

One approach, the ADAPTIVE6G architecture, collaboratively melds ML and transfer learning (TL) as a mechanism for promoting more fair and balanced network resources. This approach leverages distributed learning without reliance on central aggregation and dissemination of trained ML models. The embodiments here follow the same aim of QoS improvement, again through ML and TL, by employing semi-supervised federated learning (SSFL) methodologies to determine optimal beam vectors.

In the embodiments here, both sensor and corresponding ML edge processing nodes shall derive optimal beam predictions based on discovery of blocked line of sight (LOS) angles relative to the sensor's fixed (x, y, z) locations. The device will then use ML to develop parameters for known features, beam angles, relative to an (x, y, z) location based on unlabeled data comprised of sensed radar returned collected telemetry.

The sensor will have a known orientation and known and calibrated subsequent beam angles, allowing for determination of blockage, with respect to returned FMCW signal, to convey to learn node needed beam setting to ensure optimal performance. In addition, the node can pass learned ML parameters, in conjunction with location specific features, to a central server for aggregation and formulation of a 3D coverage map, adding in placement of RIS systems to afford improved NLOS (non-line of sight) communications.

Sensor 14, in this particular application, uses geometry to determine an image of the blockage and subsequent blocked and open radial lines are calculated. These radial lines, in conjunction with the corresponding (x, y, z) location are used to communicate to a larger 3D map performance associated with coverage and spectral efficiency. This information, collected to test and measurement systems according to embodiments herein, can empower users to plan, predict and build out a 6G network designed with precise measurements of coverage and spectral efficiency and same sensors can remain in place to monitor performance and empower formulation of digital twin representations.

Aspects of conventional techniques include an approach sometimes referred to as a “multiarmed bandit.” Users of this approach have determined that beam steering too large an overhead impacts Initial Acquisition (IA) and degrades QoS, on the order of tens to thousands of milliseconds. A need exists for a priori beam prediction. The sensors may user static learning modes to share learned models with localized user equipment (UE) rather than tie up connections between the base station (BS)/UE resources. This approach inverts the current state of the art, making it simpler and scalable; the need to direct BS/UE communication is not needed.

Turning now to FIG. 2, in one embodiment, the node device such as 14 uses knowledge of its fixed geometry to “locate” itself. The device emits a corresponding radio (radar) pulse along known radial lines. Due to their unique encoding, the signals' reflected and received signature is learned by the ML algorithm to determine at what angle it received the transmitted vectors.

More specifically, the sensor uses GPS to determine North and Zenith. Waveforms may be split into distinct halves to eliminate self-interference. This allows determination that arrival of the alternative pulses due to a neighboring sensor. The sensor emits radio pulses that have unique correlation with spherical orientation (rho, phi, theta). In the spherical orientation, rho, or r, represents the radial distance from the point in three-dimensional space to the zenith, or origin. Theta, or θ, represents the angle of the radial line from the z-axis. Phi, or φ, represents the azimuthal angle of projection of the radial line to the x-y plane. Each pulse has its own spherical orientation to allow identification of their return signals.

The device looks for return signals, or returns, at all ports. Some returns may comprise signals from neighboring nodes. Doppler analysis allows the sensor to determine if the received pulse is a return signal or from an alternate node. Once the one or more processors remove any extraneous signals, they can process the received data. The data is unlabeled but with assumptions that data is an amalgam of radar signatures (Y). SSFL looks to find expected reduced data set that represents returns due to blockages. In FIG. 2, the sensor sends out radio signals Y from ports 0, 1, 3, 5, 7 and 9.

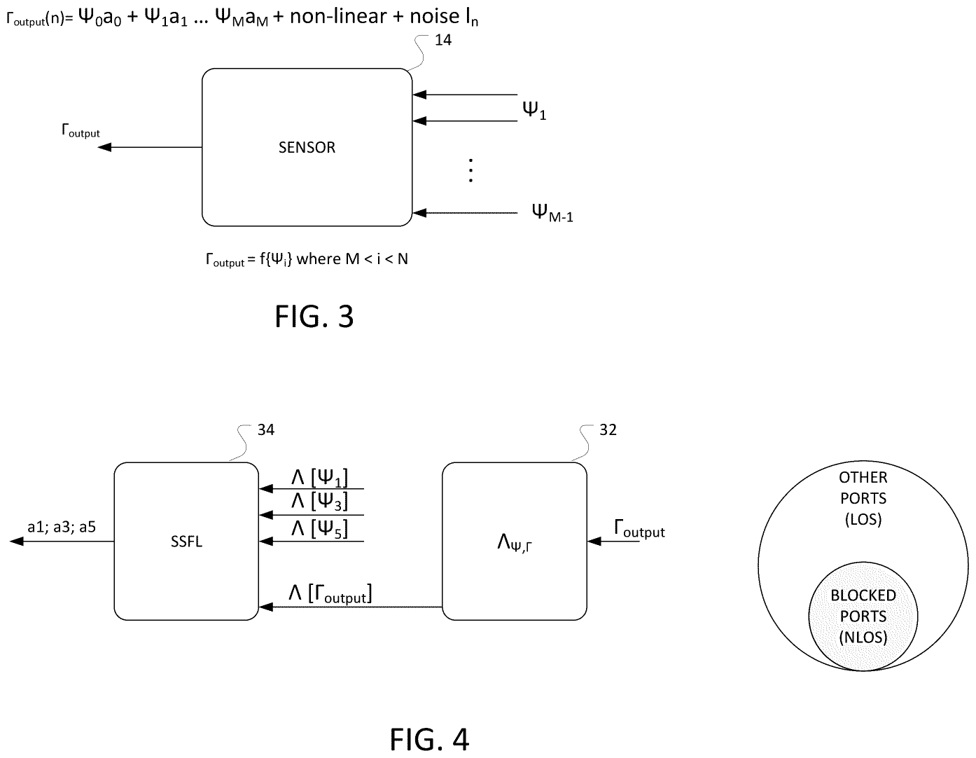

If one assumes the sensor sent N signals, the returns will receive at most N return signals, and most likely M return signals where M is less than N, represented by Γₒᵤₜₚᵤₜ, shown in FIG. 3. Direction relative to geometry will translate into angle of arrival of the radar pulse. In FIG. 2, the sensor received return signals, Ψ′, from ports 1, 3 and 5. Receiving a return signal indicates that a blockage exists from which the signals bounced back.

Use of orthogonal waveforms or cross correlation of ΓTₒᵤₜₚᵤₜ can reduce the dimension of data into the best M signatures, estimate signal-to-noise (SNR) levels, and Doppler characteristics. Parameters are used to identify block ports, leaving “unblocked” directions available for MIMO RF communications. FIG. 3 shows the sensor 32 generating an output signal, Γₒᵤₜₚᵤₜ, that includes the returns for all ports that sent signals, and any non-linear and linear noise. The SSFL 34 takes the output and the input waveforms to determine which ports are blocked.

FIG. 4 shows the output signal, Γₒᵤₜₚᵤₜ, as an input to the pre-processing block, 32 of FIG. 4, that may perform cross correlation and matrix processing using SNR ratios, such as the following matrix:

$${Λ}_{Ψ} = [ \begin{matrix}1 & 0 & 0 & 0 & 0 \\ \text{.09} & \text{.09} & 0 & 0 & 0 \\ \text{.09} & \text{.09} & \text{.9} & 0 & 0 \\ \text{.09} & \text{.09} & \text{.09} & \text{.09} & 0 \\ \text{.09} & \text{.09} & \text{.09} & \text{.09} & 1\end{matrix} ]$$

The semi-supervised machine learning network 34 in FIG. 4 then receives the resulting output from the preprocessing and the angles of the return signals to identify those ports that are blocked. The SSFL network operation will be discussed in more detail later, but generally, the local nodes receive one or more machine learning models, or algorithms, which have not been trained or are partially trained. The algorithms operate on the remote nodes, remote in that they are remote from a central node, using the local data to train the models. The remote nodes then return updates to the models that occur based upon the local data to the central node, which may then operate on the models further and re-distribute them. The term “semi-supervised” federated learning indicates the involvement of some sort of supervisor, in this case the central node. In addition to identifying the blockage and the blocked ports, the SSFL system may generate beam angles for the other ports/antennas on the node device to allow the device to operate with maximum transmission and reception efficiency. In addition, the SSFL architecture may participate in opportunistic learning of nodes that are at earlier model revisions, working collaboratively to raise all interested nodes to standard uniformity, leveraging learnings that add common optimized performance.

As a null test shown to the right of FIG. 4, the I′output, comprised of a₁, a₃, and a₅ in this embodiment, from the ML system is used to find sets of beam directions optimal for (x, y, z) location. In summary, by identifying blockage, the sensor can determine what beam angles are free or line of sight (LOS). Because the sensor knows angles of radiation based on antennas beamwidths, relative to itself, line of sight (LOS) information can be extrapolated from NLOS blocking vectors.

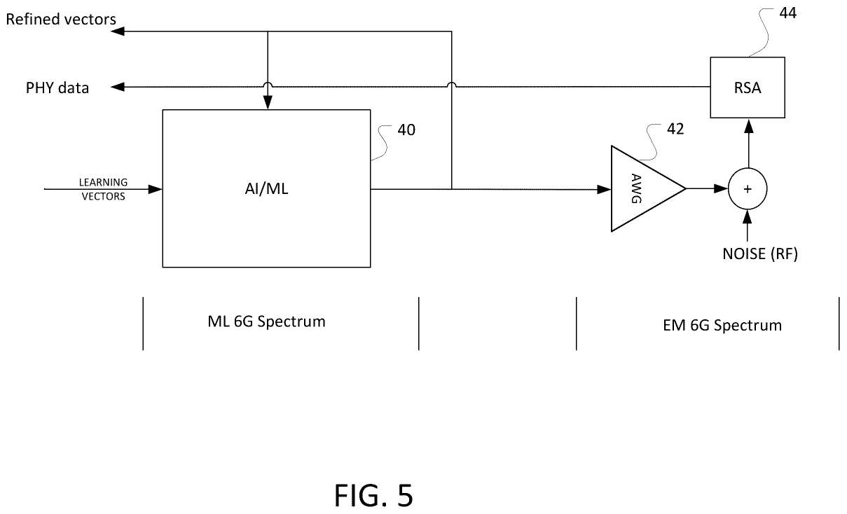

Implementation of the ML system can take many forms. Some embodiments comprise a neural network (NN), comprised of multi-level distributed processing units, which work in coordination, through sharing of test (learning) vectors for ML training, and take receipt of physical layer (PHY) measurements to validate or monitor changes to end nodes. FIG. 5 shows an example of a machine learning network 40 and its interaction with a test and measurement instrument residing in the network to provide PHY measurements. This forms part of the network management system to monitor and update information in the network as needed.

The ML network operates on nodes in the 6G spectrum, in this example, and the test and measurement device resides in the network, possibly at an edge, and tests the resulting outputs of the machine learning network. The ML network 40, which may be distributed across many of the nodes of the network, operates on the learning vectors and produces an output. The test and measurement device receives the output and uses an arbitrary waveform generator 42 to provide a signal with which the output is combined. Noise from the system may be added into the resulting signal. A real-time spectrum analyzer (RSA) 44 or other test and measurement instrument that can analyze electromagnetic signals provides data related to the PHY layer correlation with the end node.

Each node may contain a ML convergence engine capable of receiving prescribed information, acting on that information, ideally through execution of an algorithm, and determining change parameters to the prescribed data for passage back to the node that delivered the task. The node then establishes a bidirectional link that allows for transmission of learning data (vectors) through the network, and passage back into the network of PHY layer data for correlation of cause with effect, marking system state over time. Alternatively, each node may take receipt of data processed by a more capable sensor.

In addition, some embodiments of the disclosure may use predictive assessment of beam steering (codebooks) or channel estimations using knowledge of sensor capabilities to train neural networks that are unique to a specific implementation location/environment.

Some embodiments of the disclosure use hybrid centralized federated learning, referred to hear as semi-supervised federated learning, to collect non-independent-identically-distributed (non-iid) signals for estimation of parameters that are common to all channels and are independent to a specific channel. Depending on the application, the instrument, or product, housing the NN estimates the needed parameters based on telemetry from each individual channel or an ensemble of measurements across many channels. This learning defines the parameters of the NN for a common model, the attributes of which are shared across each channel or refined across multiple channels, each having their own independent model that is germane to their test and measurement scenario.

Embodiments of the disclosure limit needed processing by only sharing minimal parameters between the one NN or amongst each of the unique NN, ascribed to each channel or to each individual channel. Federated Learning enables training of models on distributed data without requiring the raw data to be pulled from a mobile device at a node in the network to a central server, such as 16 in FIG. 1. Instead, raw data remains local on devices at remote nodes, and the models are collaboratively trained across a trusted group on each localized device. Only the model updates are shared to the server, nodes, or clients, which is later aggregated on the central server. With federated learning, one can ensure privacy of data collected on devices and save the bandwidth by avoiding having to send all the data, while unlocking access to a large amount of data distributed over devices.

Bootstrap convolutional neural network (CNN) models can be learned quickly and are nimble to situational changes, and the nodes can report changes for refinement of future bootstrap models. As used herein, the term “bootstrap” means factory default models, those that remain in the original state since being designed. Once these models are reported back to a centralized server, an aggregator, a boot strap model can be relayed to manufacturing to refine future DUTs' design iterations, forming a linkage between field and factory, and bringing “real-world” data into the traditionally isolated Accelerated Life, Range, or Anechoic Chamber testing. With respect to Digital Twinning (DT) discussed below, the bootstrap model will serve as the latest digital representation of the DUT's performance or perceptions. A Digital Twin means a data driven representation of a DUT's performance in situation, or in situ, and leads to optimal designs for a targeted scenario, application, and environment all based on T&M measurement of the fundamentals. In short, it establishes a pathway for migration of “real-world” data back to manufacturing that is both lightweight and data efficient, empowering our customers through ML-enhanced Tektronix equipment.

Digital twinning, a process of developing a model that is a digital representation of a DUT, such as a node device in the communication network, may provide some advantages here. They may provide some key features, including, but not limited to 3D mapping through multi-modal sensing, wireless communication system enablement, and real-world PHY layer mirroring. This allows for the creation of facsimiles that empower customers to make data driven decisions before changes to the nominal (primary) system, thereby minimizing QoS (Quality of Service) or SLA (Service Level Agreement) impacts.

These key features result from telemetry from high-fidelity integrated sensing and communication (ISAC) to empower DT facsimiles and permit ML algorithm training or infrastructure sustainment. For 6G communication systems similar enablement features serve to interconnect traditionally distinct realms such as terrestrial with non-terrestrial networks, factories with end users, and virtual with real. A realm's merger will undoubtedly manifest in 3D mapping derived via multi-modal sensing, allowing for prediction of infrastructure configurations to optimize communication performance, aiding infrastructure planners and service providers, ensuring minimal deployment cost and maximum quality of service (Qos) offering.

Enhanced infrastructure planning capability will allow 6G ecosystem providers to optimize performance, localized to a specific 3D location, achieving targeted spectral efficiency (bps/Hz) or coverage (EIRP, dBm) aims. Aims whose coverage probability and ergodic capacity are bounded by Joint Communication and Sensing System (JCAS) limits.

Current JCAS evolution manifests now as an ISAC yet employs similar metrics to determine optimal PHY layer beam pointing vectors configurations for across disjoint 6G bands, such as mmWave and THz bands, to circumvent blockage conditions. Radar chip signals allow for determination of blockage discussed above to make informed decisions, fulfilling necessary ISAC roles.

A digital twin of a device may provide sensing aided beam prediction, sensing aided blockage, and hand-off prediction. Digital twinning may also provide ancillary communications support and sustainment. The DT allows for a system whose role is more metrological in nature, aligning more with sensing and support, and having less of a communication function, but adheres and adapts to communications needs, if tasked, is herein referred to as a metrology ISAC (M-ISAC). This M-ISAC system, comprised of disaggregated sensors, either radar or communications agility, and having ML federated learning capabilities, may be employed in embodiments herein.

Embodiments of the disclosure find value in having a large data set, packaged in portable CNNs, that use data such as images to characterize learned attributes that can be cataloged, tested, validated, and inferred. It provides a grand “engineering notebook” that keeps track of every and all observations and formulated predictions that must be validated before considered to be infallible. This is possible due to the linkage established between field and manufacturing.

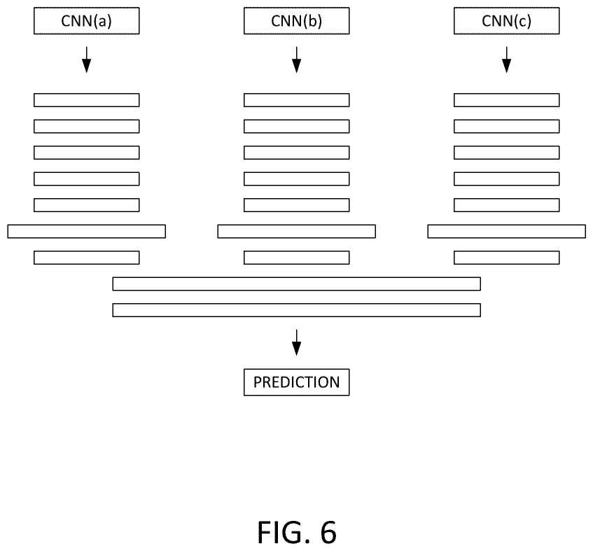

The embodiments here apply these concepts to a communication network. The embodiments of the disclosure generally use a performance metric and multiple convolutional neural network (CNN) models, termed an ensemble, interconnected by fully connected layers, and not a single CNN. FIG. 6 shows a block diagram of an ensemble CNN. Each CNN, a, b, and c, have individual layers, typically the fully connected layers of the overall neural network, with the common layers, typically the convolutional layers, shared between all the networks in the ensemble.

Incorporating federated learning into the system allows for more accurate measurement of heterogenous data, non-independent identically distributed data with “concept shifts.” Concept Shifts check to see, if given various vantage points, does the system arrive at the same result with high precision and relative frequency, without relying on exchange of data between centralized server and remote (spur) sensors. For example, some nodes in a communication network may have data than other nodes, referred to as quantity skew. As an example, consider a federated learning scenario in which the machine learning network classifies cars versus trucks. Nodes that reside and operate in environments with different sized vehicles, such as Japan that has many more compact cars and trucks, may operate on the same data differently, possibly classifying larger cars as trucks. This difference in interpretation of features is referred to as feature skew.

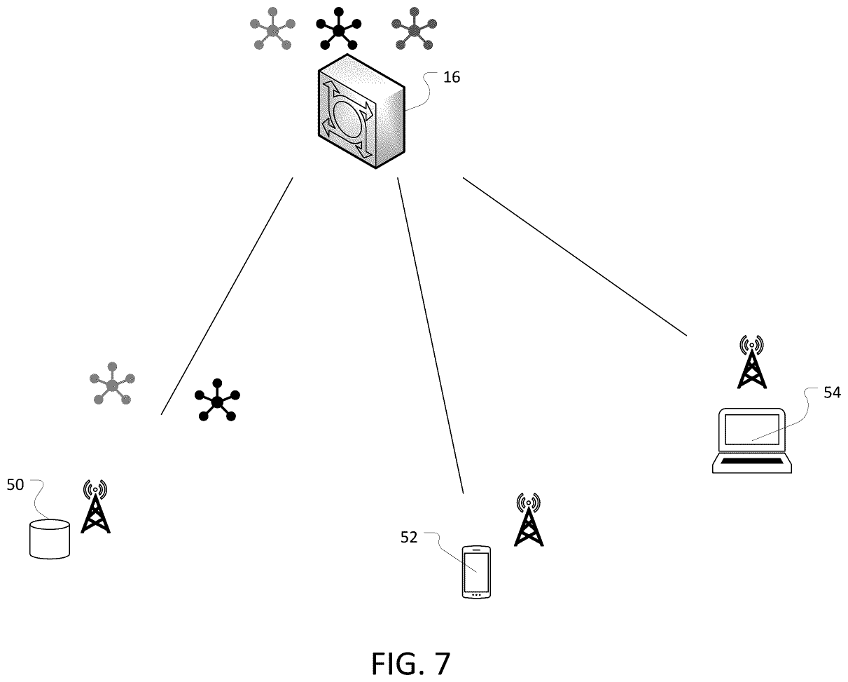

Using neural networks split between a central server and remote system, shown in FIG. 7, can alleviate some of these issues. The global part of the model consists of all the convolutional layers, for CNNs, shared with the server or base station such as 16. The other half, the fully connected layers, for example, that form the local part of the model, stay with individual clients, probes, or sensors such as 50, 52 and 54. In short, spurs, representing data collection by each remote node, whether wired, wireless or optical, contain simply the fully connected layer. The sharing of the updated models and critical data can “smooth” out the information across the network to alleviate issues with quantity and feature skew.

Additionally, one can cluster the nodes so that the central aggregation server does not need to ask for raw data which preserves privacy. This both preserves bandwidth for the communications network to use in operation, rather than in the network management aspects here. The network may cluster nodes for the most efficient training in federated learning. For example, nodes that have a same type, such as test and measurement instruments, mobile phones, or servers, may benefit from being clustered and they all “learn” in a similar fashion. Nodes that reside in a same geographical region may benefit from clustering based upon their proximity and similar operating environments. Nodes may cluster based upon a type of data they handle, such as test and measurement data, communications based upon a particular protocol, etc. These provide just examples of clustering across a network of possibly hundreds of thousands of nodes. Each cluster may have a central node that communicates with a higher-level central node, etc. In addition, the functionality may be embodied in whole or in part in firmware or hardware equivalents such as integrated circuits, FPGA, and the like, leveraging high-speed data converter interfaces by splitting data between TMS needs and nominal radio (system) operations.

The communication network and its nodes described here employ split neural networks to limit transport of large bandwidth data sets on available interconnects or backhaul connections. Instead, lightweight traffic is exchanged between nodes such as sensors/instruments and centralized servers, central nodes. Testing may take the form of presenting an exemplar pair of data at various vantage points and measurement instances to check and train the devices at the node to ensure it predicts an outcome with high precision and relative frequency.

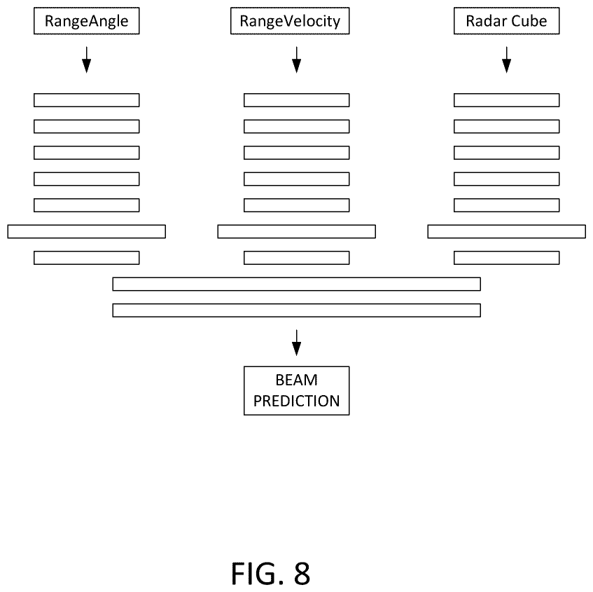

FIG. 8 shows an embodiment of a split or bifurcated machine learning network for a communication network, being split between the distributed nodes (local) and the central processing unit (global). The central processing unit could reside at various network levels spanning the edge to the cloud. In this embodiment, as an example, the three different neural networks each have a particular aspect of beam steering, including the range and angle, range and velocity, and the beam cube, to produce a predicted beam angle for an antenna or antenna array in the communication network.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a communication network, comprising multiple nodes, each node comprising: one or more antennas; one or more input ports configured to receive communication signals from the antenna from other nodes in the network; one or more output ports configured to transmit signals through the antenna to other nodes in the network; a memory to store data associated with the communication signals; and one or more processors configured to execute code to cause the one or more processors to: gather local data about an environment in which the node operates; communicate with one or more other nodes as needed to send local data; and use the local data to determine optimized operational settings for the node in the communications network.

Example 2 is the communications network of Example 1, wherein at least one node comprises a sensor node, and the one or more processors in the sensor node are further configured to: determine a position of the sensor node; emit pulses having unique correlations with spherical location; receive return signals from the input ports; and determine if the return signals indicate that a blockage exists in the communications network.

Example 3 is the communication network of Example 2, wherein the one or more processors are further configured to execute code that causes the one or more processors to determine optimized angles for unblocked ports of the device.

Example 4 is the communication network of Example 2, wherein the code that causes the one or more processors to communicate with one or mode nodes comprises code that causes the one or more processors to: communicate with a central node; reduce data derived from the return signal to produce a reduced data set; and transmit the reduced data set to the central node.

Example 5 is the communication network of any of Examples 1 through, wherein the code that causes the one or more processors to gather local data and communicate with the one or more other nodes comprises code that causes the one or more processors to: communicate with a central node; receive one or more machine learning models from the central node; use the local data to train at least one of the one or more models on the node; and send only updated models to the central node.

Example 6 is the communication network of Example 5, wherein the code that causes the one or more processors to receive one or more machine learning models from the central node comprises code that causes the one or more processors to receive only a local part of the one or more machine learning models.

Example 7 is the communication network of any of Examples 1 through 6, wherein the node comprises a central node, and the code that causes the one or more processors to communicate with other nodes comprises code that causes the one or more processors to: operate upon a global portion of the one or more machine learning models; receive updated data from local nodes; update the global portion of the one or more machine learning models; and transmit the updated global portion of the one or more machine learning models as needed.

Example 8 is the communications network of any of Examples 1 through 7, wherein each node of the multiple nodes comprises at least one of: a communications device, a sensing device, a test and measurement instrument, and a reconfigurable intelligent surface.

Example 9 is the communication network of any of Examples 1 through 9, wherein the information about the local environment comprises physical layer information about a device under test residing at the node.

Example 10 is the communication network of Example 9, wherein the physical layer comprises at least one of electrical, mechanical, optical, acoustic, and thermal.

Example 11 is a sensor device, comprising: one or more antennas to allow the device to receive communication signals from other nodes in a communication network; one or more input ports configured to receive the communication signals; one or more output ports configured to transmit communication signals to other nodes in the network through the one or more antennas; a memory to store data associated with the communication signals; and one or more processors configured to execute code to cause the one or more processors to: determine a position of the sensor device; transmit signals through the output ports, each signal having a unique spherical orientation identifier; receive return signals through the one or more input ports; separate return signals from other received signals and to produce return signal data; and process the return signal data with a machine learning system to identify unblocked ports.

Example 12 is the sensor device of Examples 11, wherein the one or more processors are further configured execute code to cause the one or more optimized beam directions for the one or more antennas.

Example 13 is the sensor device of either of Examples 11 or 12, wherein the codes that causes the one or more processors to separate the return signals comprises code that causes the one or more processors to: use Doppler analysis to identify signals from neighboring nodes; and remove those signals from the return signals.

Example 14 is the sensor device of any of Examples 11 through 13, wherein the code that causes the one or more processors to process the return signals comprises code that causes the one or more processors to: determine a direction of each return signal received; and translate the direction of each return signal in an angle of the return signal to identify that angle as an unblocked angle.

Example 15 is the sensor device of any of Examples 11 through 14, wherein the code that causes the one or more processors to process the return signals causes the one or more processors to: identify ports for which no return signal was returned; and identify the ports for which no return signal was returned as blocked ports.

Example 16 is a method of operating a communication network having multiple nodes and a central node, comprising: transmitting, from a central node, a bootstrap model for a machine learning system; receiving the bootstrap model by at least one remote node; collecting data local to the at least one remote mode about an environment in which the remote node operates; using the data local to the at least one remote mode to train the bootstrap model; and sending updated models to the central node.

Example 17 is the method of Example 16, further comprising: clustering the at least one remote node with other remote nodes; and sending updates to the central node from the cluster.

Example 18 is the method of Example 17, wherein the clustering comprises clustering the at least one node and the other remote nodes is based upon one or more of a type of node, a localized geographic region, and a type of data local to the at least one remote node and other remote nodes.

Additionally, this written description makes reference to particular features. It is to be understood that the disclosure in this specification includes all possible combinations of those particular features. For example, where a particular feature is disclosed in the context of a particular aspect, that feature can also be used, to the extent possible, in the context of other aspects.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific aspects of this disclosure have been illustrated and described for purposes of illustration, it will be understood that various modifications may be made without departing from the spirit and scope of the invention. Accordingly, the invention should not be limited except as by the appended claims.

1. A communication network, comprising multiple nodes, each node comprising:
one or more antennas;
one or more input ports configured to receive communication signals from the antenna from other nodes in the network;
one or more output ports configured to transmit signals through the antenna to other nodes in the network;
a memory to store data associated with the communication signals; and
one or more processors configured to execute code to cause the one or more processors to:
gather local data about an environment in which the node operates;
communicate with one or more other nodes as needed to send local data; and
use the local data to determine optimized operational settings for the node in the communications network.

2. The communications network as claimed in claim 1, wherein at least one node comprises a sensor node, and the one or more processors in the sensor node are further configured to:
determine a position of the sensor node;
emit pulses having unique correlations with spherical location;
receive return signals from the input ports; and
determine if the return signals indicate that a blockage exists in the communications network.

3. The communication network as claimed in claim 2, wherein the one or more processors are further configured to execute code that causes the one or more processors to determine optimized angles for unblocked ports of the device.

4. The communication network as claimed in claim 2, wherein the code that causes the one or more processors to communicate with one or mode nodes comprises code that causes the one or more processors to:
communicate with a central node;
reduce data derived from the return signal to produce a reduced data set; and
transmit the reduced data set to the central node.

5. The communication network as claimed in claim 1, wherein the code that causes the one or more processors to gather local data and communicate with the one or more other nodes comprises code that causes the one or more processors to:
communicate with a central node;
receive one or more machine learning models from the central node;
use the local data to train at least one of the one or more models on the node; and
send only updated models to the central node.

6. The communication network as claimed in claim 5, wherein the code that causes the one or more processors to receive one or more machine learning models from the central node comprises code that causes the one or more processors to receive only a local part of the one or more machine learning models.

7. The communication network as claimed in claim 1, wherein the node comprises a central node, and the code that causes the one or more processors to communicate with other nodes comprises code that causes the one or more processors to:
operate upon a global portion of the one or more machine learning models;
receive updated data from local nodes;
update the global portion of the one or more machine learning models; and
transmit the updated global portion of the one or more machine learning models as needed.

8. The communications network as claimed in claim 1, wherein each node of the multiple nodes comprises at least one of: a communications device, a sensing device, a test and measurement instrument, and a reconfigurable intelligent surface.

9. The communication network as claimed in claim 1, wherein the information about the local environment comprises physical layer information about a device under test residing at the node.

10. The communication network as claimed in claim 9, wherein the physical layer comprises at least one of electrical, mechanical, optical, acoustic, and thermal.

11. A sensor device, comprising:
one or more antennas to allow the device to receive communication signals from other nodes in a communication network;
one or more input ports configured to receive the communication signals;
one or more output ports configured to transmit communication signals to other nodes in the network through the one or more antennas;
a memory to store data associated with the communication signals; and
one or more processors configured to execute code to cause the one or more processors to:
determine a position of the sensor device;
transmit signals through the output ports, each signal having a unique spherical orientation identifier;
receive return signals through the one or more input ports;
separate return signals from other received signals and to produce return signal data; and
process the return signal data with a machine learning system to identify unblocked ports.

12. The sensor device as claimed in claim 11, wherein the one or more processors are further configured execute code to cause the one or more optimized beam directions for the one or more antennas.

13. The sensor device as claimed in claim 11, wherein the codes that causes the one or more processors to separate the return signals comprises code that causes the one or more processors to:
use Doppler analysis to identify signals from neighboring nodes; and
remove those signals from the return signals.

14. The sensor device as claimed in claim 11, wherein the code that causes the one or more processors to process the return signals comprises code that causes the one or more processors to:
determine a direction of each return signal received; and
translate the direction of each return signal in an angle of the return signal to identify that angle as an unblocked angle.

15. The sensor device as claimed in claim 11, wherein the code that causes the one or more processors to process the return signals causes the one or more processors to:
identify ports for which no return signal was returned; and
identify the ports for which no return signal was returned as blocked ports.

16. A method of operating a communication network having multiple nodes and a central node, comprising:
transmitting, from a central node, a bootstrap model for a machine learning system;
receiving the bootstrap model by at least one remote node;
collecting data local to the at least one remote mode about an environment in which the remote node operates;
using the data local to the at least one remote mode to train the bootstrap model; and
sending updated models to the central node.

17. The method as claimed in claim 16, further comprising:
clustering the at least one remote node with other remote nodes; and
sending updates to the central node from the cluster.

18. The method as claimed in claim 17, wherein the clustering comprises clustering the at least one node and the other remote nodes is based upon one or more of a type of node, a localized geographic region, and a type of data local to the at least one remote node and other remote nodes.
